(19) United States
(12) Patent Application Publication
(10) Pub. No.: US 2002/0105768 A1
(43) Pub. Date: Aug. 8, 2002

(54) Circuit breaker

(76) Inventors: Noboru Yamaguchi, Shizuoka-ken (JP); Yasuhiro Tamai, Shizuoka-ken (JP)

Correspondence Address: FINNEGAN, HENDERSON, FARABOW, GARRETT &, DUNNER LLP, 1300 I STREET, NW, WASHINGTON, DC, 20005, US

(21) Appl. No.: 09/777,881

(22) Filed: Feb. 7, 2001

(51) Int. Cl. H02H 3/08

(52) U.S. Cl. 361/93.9; 361/58

(57) ABSTRACT

A circuit breaker is provided with diagnostic function allowing a user to know whether the circuit breaker is operated normally. The circuit breaker includes a breaker unit 10 for breaking a current flowing from a battery VB to a load 17, a switching element 42 for driving the breaker unit 10 in response to a collision signal, a self-diagnostic part 41 for responding diagnostic signals to diagnose the normality of a line from the battery VB to the unit 10 via the switching element 42, a transistor Tr, a light-emitting diode LED and a resistance R. With the structure of the circuit breaker, by supplying the circuit breaker with the diagnostic signals at appropriate intervals, the user can detect whether peripheral circuits of the breaker unit have any trouble in operation.

### BACKGROUND OF THE INVENTION

The present invention relates to a circuit breaker for breaking an electric circuit installed in a vehicle or the like, in a short time. More particularly, it relates to the circuit breaker which is capable of self-diagnosis for an electric circuit surrounding the circuit breaker.

In the prior art, there is known a circuit breaker for a vehicle, which breaks a current to a load as soon as the vehicle has a collision. For example, Japanese Unexamined Patent Publication No. 8-72634 discloses an automotive current distribution system equipped with the above circuit breaker.

FIG. 1 illustrates the automotive current distribution system of the publication.

The automotive current distribution system includes a first fusible link 52 having an end connected to an alternator (ALT) 51 and a second fusible link 54 connected to a positive terminal of a battery 53. The other ends of the fusible links 42 and 54 are together connected with an input terminal of a junction box 55 in an engine room. The junction box 55 has a plurality of output terminals connected with respective ends of electrical loads (direct lamps, motors, ignition, etc.) through switches, respectively. In the figure, one electric load 57 and one switch 56 are shown in pairs. The other ends of the loads 57 are connected to a vehicle body for ground, as similar to the other end of the battery 53.

In the junction box 55, there are accommodated, between the input terminal and the output terminals, a plurality of series circuits each consisting of a fuse FS and a relay RL, and also a relay 50 in connection with an air-bag system. As for the operation of these series circuits, for example, when the switch 56 is turned ON, then the relay RL is activated to supply electricity to the load 57. While, the relay 50 is provided with a relay coil having an end connected with an air-bag sensor (not shown) and the other end connected with the vehicle body for ground. In the relay 50, a normally open contact has an end connected with the input terminal of the junction box 55 and the other end connected with the vehicle body.

In the so-constructed current distribution system, when an ignition switch (not shown) is turned ON to start the engine, the electric current from the battery 53 is fed to the junction box 55. After starting the engine, the battery 53 and the junction box 55 are supplied with a current as a result of rectifying an alternating current generated by the alternator 51. In this way, with the switch 56 turning ON, the current can be provided to the load 57 through the output terminal of the junction box 55.

Meanwhile, if the vehicle has a collision, then the alternator 51 ceases generating the electric power, so that no current is supplied from the alternator 55 to the junction box 55; nevertheless the battery 53 goes on supplying the current to the junction box 55. Under such a situation, when the current of detection is supplied from the air-bag sensor, the relay coil in the relay 50 is excited to activate the normally-opened contacts in the ON state. As a result, a short-circuit current flows from the battery 53 to the vehicle body through the second fusible link 54 and the sequent relay 50. This flow of short-circuit current causes the second fusible link 54 to be heated for melting, so that the current to the load 57 is cut off. In this way, the load itself, a wire harness extending from the battery 53 to the load, etc. are prevented from being influenced in thermal.

However, the above-mentioned automotive current delivery system disclosed in JUPP No. 8-72634 does not have a function to detect an obstacle (e.g. breaking-down, short-circuit, etc.) occurring in the peripheral circuit of the relay as the circuit breaker. Thus, if the current line extending from e.g. the air-bag sensor to the relay 50 has such an obstacle, the relay 50 could not so operate normally thereby to make it impossible to cut off the flow of current from the battery 53 to the load 57. Under such a situation, it has been requested that, at an appropriate opportunity, for example, before or after starting the engine, the system is capable of diagnosing whether the circuit breaker operates normally.

### SUMMARY OF THE INVENTION

Under the circumstances, it is therefore an object of the present invention to provide a circuit breaker which allows a user to know whether the circuit breaker operates normally.

The object of the present invention described above can be accomplished by a circuit breaker for a vehicle, comprising:

a power source;

an electric load connected to the power source and also driven by the power sources;

a breaker unit disposed between the power source and the electric load, for breaking a current flowing from the power source to the electric load;

a driving unit disposed between the breaker unit and the power source to drive the breaker unit in response to an abnormality signal inputted from an outside of the breaker unit when the vehicle has an abnormality; and

a self-diagnostic unit connected to the driving unit to diagnose a normality of a current line from the power source to the breaker unit via the driving unit in response to a diagnostic signal inputted from an outside of the self-diagnostic unit.

With the above-mentioned structure, upon supply of the diagnostic signal, the self-diagnostic unit diagnoses the normality of circuits behind and before the driving unit for driving the breaker unit breaking the current flowing from the power source to the load in response to the abnormality signal from the outside, in other words, the normality of the current line from the power source to the breaker unit via the driving unit. Consequently, with the supply of the circuit breaker with the diagnostic signals at appropriate intervals, the user can know whether an obstacle exists in circuits in the periphery of the breaker unit.

As the second aspect of the invention, the above-mentioned circuit breaker further comprises a display unit connected to the power source to display the current's flowing to an outside of the display unit and a current limiting unit connected to the display unit to restrict a current for driving the driving unit. In the circuit breaker, the self-diagnostic unit has a line switching circuit for switching the current line between a first current line extending from the power source to the driving unit directly and a second current line from the power source to the driving unit via the display unit and the current limiting unit; and the self-diagnostic unit diagnoses the normality upon switching the current line to the second current line in response to the diagnostic signal.

According to the second aspect of the invention, in response to the diagnostic signal, the current line is switched to the second current line from the power source to driving unit via the display unit and the current limiting unit and the diagnosis about normality is carried out by using the second current line.

At As the third aspect of the invention, the circuit breaker of the second aspect further comprises a first judging unit connected to the first current line to judge whether the first current line has an obstacle in flowing the current. In this circuit breaker, the obstacle of the first current line is judged by the first judging unit and the self-diagnostic unit allows the line switching circuit to switch the current line to the second current line thereby to diagnose the normality of the current line.

Besides the case of a diagnostic signal being supplied, when it is judged by the first judging unit that the first current line has an obstacle, then the current line is switched to the second current line by the line switching. Accordingly, even if, for example, a harness connecting the power source with the breaker unit is detached during the vehicle's traveling, the diagnosis allows the user to be informed of a diagnosis result, enhancing the safety of the circuit breaker furthermore.

As the fourth aspect of the invention, in the current breaker of the first aspect, the driving unit is adapted so as to receive a breaking signal to instruct the breaker unit to break the current flowing from the power source to the electric load, as the abnormality signal. Further, the driving unit is adapted so as to drive the breaker unit in response to the breaking signal.

In this case, the breaker unit is driven in response to the breaking signal. Therefore, for example, if the current breaker is constructed so as to generate the diagnostic signal when it is desired to stop the vehicle urgently or when the vehicle is stolen, then it is possible to stop the vehicle in such cases surely,

As the fifth aspect of the invention, in the current breaker of the first aspect, the driving unit is adapted so as to receive a collision signal representing the occurrence of an impact on the vehicle, as the abnormality signal. Further, the driving unit is adapted so as to drive the breaker unit in response to the collision signal.

In this case, since the breaker unit is operated in response to the collision signal representing the occurrence of collision about the vehicle, it is possible to insulate the flow of current from the power source to the load.

As the sixth aspect of the invention, the circuit breaker of the first aspect further comprises a current detecting unit interposed in the current line to detect the current flowing from the power source to the electric load, and a second judging unit connected to the current detecting unit to judge whether a value of the current detected by the current detecting unit is more than a predetermined threshold value, the second judging unit further outputting the abnormality signal to the driving unit when the value of the current is more than the predetermined threshold value. In this circuit breaker, the driving unit drives the breaker unit in response to the abnormality signal from the second judging unit,

Since the second judging unit generates the abnormality signal to the driving unit in case of the current being more than the predetermined threshold value and further the driving unit drives the breaker unit in response to the abnormality signal from the second judging unit, it is also possible to insulate the flow of current from the power source to the load.

As the sixth aspect of the invention, in the circuit breaker of the first aspect, the self-diagnostic unit is adapted so as to receive a start signal instructing the vehicle to start, as the diagnostic signal. Farther, the self-diagnostic unit is adapted so as to diagnose the normality of the current line from the power source to the breaker unit via the driving unit in response to the start signal.

For example, when the start signal is supplied in response to the user's manipulating of an ignition key, the current line from the power source to the breaker unit via the driving unit is diagnosed in its normality, performing the checking operation about the circuit breaker, as one item of an inspection for starting.

Noted, in the circuit breaker of the second aspect, the display unit may be formed by a light-emitting diode. Similarly, the current limiting unit may be formed by a resistance.

These and other objects and features of the present invention will become more fully apparent from the following description and appended claims taken in conjunction with the accompany drawings.

### BRIEF DESCRIPTION OF THE DRAWINGS

FIG. 1 is a diagram for explanation of an automotive current distributing system as the conventional circuit breaker;

FIG. 2 is a block diagram showing the structure of an electric circuit of a circuit breaker in accordance with an embodiment of the present invention;

FIG. 3 is a sectional view of a breaker unit in FIG. 2, showing its condition before breaking a circuit;

FIG. 4 is a top view of the breaking unit of FIG. 2;

FIG. 5 is a detailed perspective view showing respective screw parts: one being formed on a thermit casing; and the other being formed on a step part of an outer casing of FIG. 3;

FIG. 6 is a sectional view of the breaking unit of FIG. 2, showing the condition after breaking the circuit; and

FIG. 7 is a circuit diagram showing the structure of a circuit in place of a line switching relay of FIG. 2.

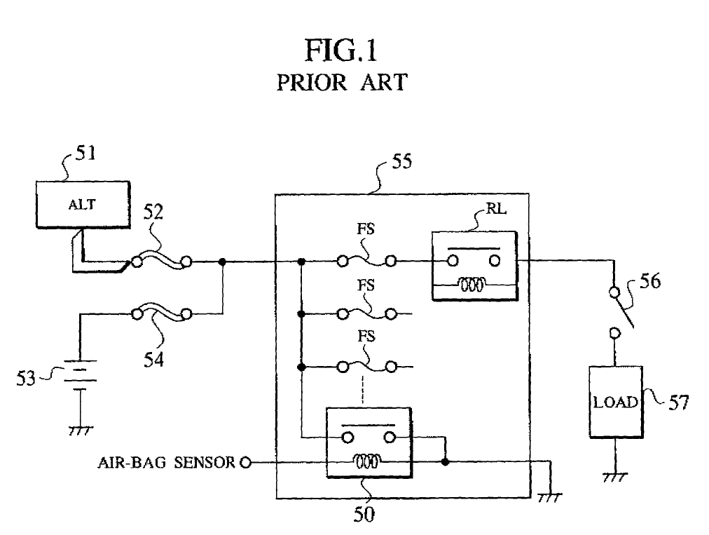

### DESCRIPTION OF THE PREFERRED EMBODIMENT

An embodiment of the present invention will be described with reference to the drawings.

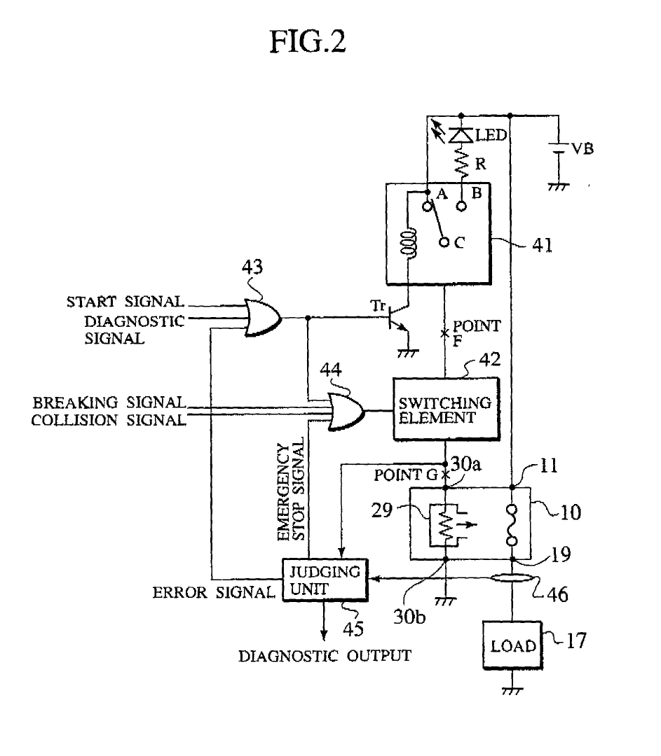

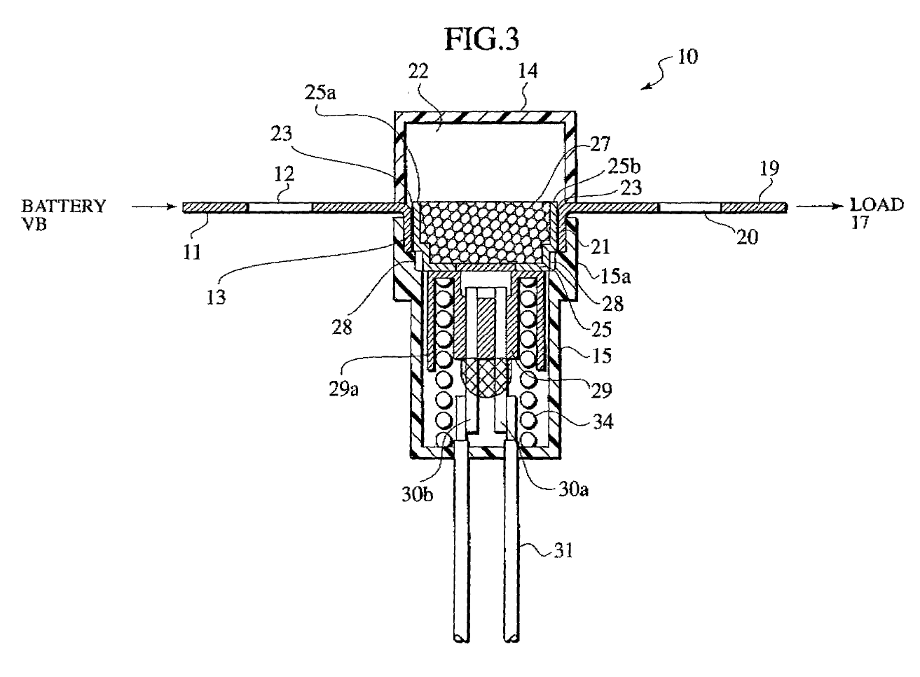

FIG. 2 is a block diagram showing the structure of an electric circuit of a circuit breaker of the embodiment of the invention. Prior to an explanation of the electric circuit, we now describe the detailed structure of a breaker unit 10 as a main constituent of the circuit breaker with reference to FIGS. 3 to 6.

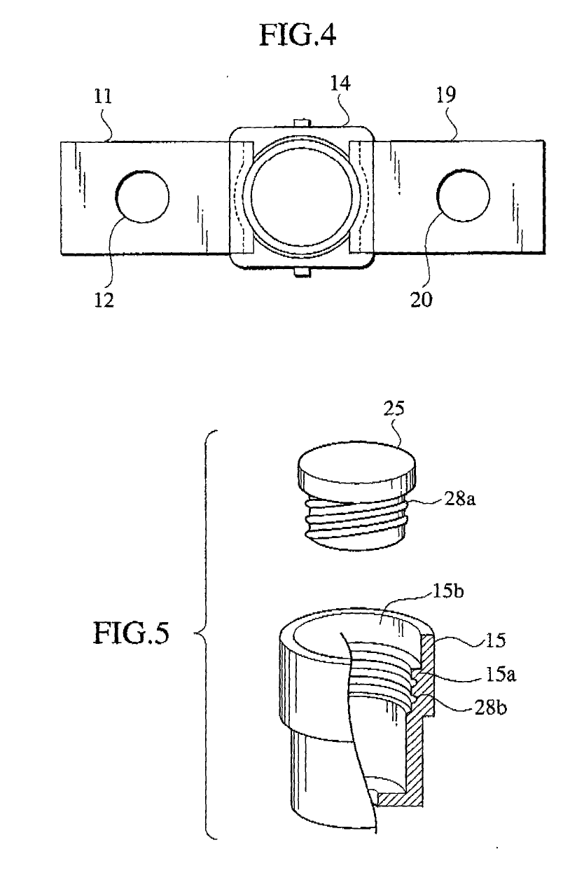

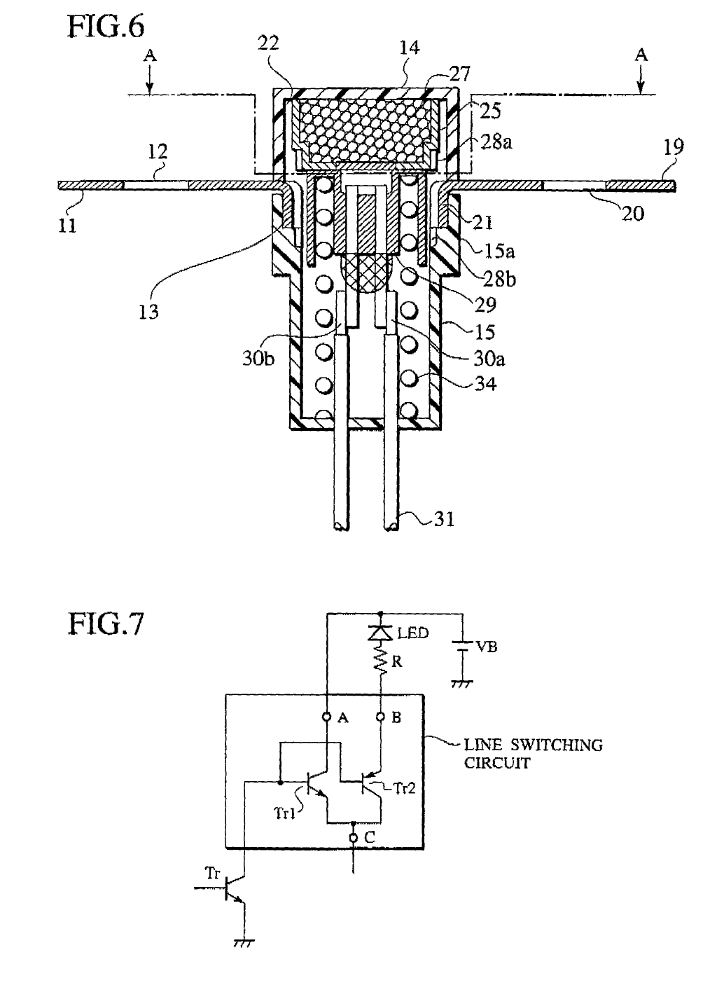

FIG. 3 is a sectional view of the breaker unit 10 before its breaking operation. FIG. 4 is a top view of the breaker unit 10. FIG. 5 is a detailed perspective view showing respective screw parts formed on a thermit casing and a step part of an outer casing. FIG. 6 is a sectional view of the circuit breaker unit 10 after the breaking operation. Note, FIG. 4 shows the breaker unit 10 where a cap 14 is detached.

In the breaker unit 10 of FIG. 3, a first bus bar 11 in the form of a long plate is made of, for example, copper or copper alloy and has a hole 12 formed for connection with a battery VB (see FIG. 2). A leading end 13 of the first bus bar 11 is bent downward to the remainder at about right angles.

Similarly, a second bus bar 19 in the form of a long plate is made of, for example, copper or copper alloy and has a hole 20 formed for connection with an electric load 17 (see FIG. 2). A leading end 21 of the second bus bar 19 is also bent downward to the remainder at about right angles.

Between the first bus bar 11 and the second bus bar 19, there are arranged, on the upper side, a cap 14 having a cavity 22 and on the lower side, an outer casing 15 having a step part 15a. The cap 14 and the outer casing 15 form an outer container made of insulating material, such as resin (thermoplastic resin).

A thermit casing 25 in the form of a lid is accommodated in the outer casing 15 and also filled up with heating agents 27. Preferably, the thermit casing 25 is made from material exhibiting high thermal conductivity and being insoluble by heating of the heating agents 27, for example, copper pyrites, copper, copper alloy, stainless, etc.

The thermit casing 25 is arranged to be substantially level with the first bus bar 11 and the second bus bar 19. The thermit casing 25 includes a left sidewall 25a and a right sidewall 25b.

The left sidewall 25a is welded to the leading end 13 of the first bus bar 11 by a metal 23 having a low melting point, such as solder (melting point: 200 to 300° C.). The right sidewall 25b is welded to the leading end 21 of the second bus bar 19 by another metal 23. Thus, through the metals 23 and the thermit casing 25, the first bus bar 11 is electrically connected with the second bus bar 19.

As the “low-melting point” metal 23, the material consists of at least one kind of metal to be selected from e.g. Sn, Pb, Zn, Al and Cu.

The heating agents 27, which may be made from powder of metal oxide, such as iron oxide (Fe₂O₃), aluminum powder or the like, is identical to thermit agents where a thermit reaction is caused by the heat generation of leads 30a and 30b coupled to lead wires 31 thereby to generate high fever. Note, the iron oxide (Fe₂O₃) may be replaced by chromium oxide (Cr₂O₃), manganese oxide (MnO₂), etc,

As the heating agents 27, it may be formed by at least one kind of mixture of, at least one metal powder selected from elements B, Sn, FeSi, Zr, Ti and Al; at least on metal oxide selected from metal oxides CuO, MnO₂, Pb₃O₄, PbO₂, Fe₃O₄ and Fe₂O₃; and additive agents, such as alumina, bentonite, talc. With such a composition, the heating agents 27 can be ignited by an ignitor 29 with ease, allowing the low-melting point metals 23 to be molten in a short time.

The outer casing 15 has a screw part 28 formed on its inner peripheral face facing the lower part of the thermit casing 25, for fastening it. In assembly, the thermit casing 25 can be accommodated in a thermit receiving part 15b formed on the step part 15a of the outer casing 15, as shown in FIG. 5.

The above screw part 28 consists of a “thermit-side” screw part 28a in the form of a male screw formed in the thermit casing 25 and an “outer casing-side” screw part 28b in the form of a female screw formed on the step part 15a, for engagement with the part 28a. At least either the part 28a or the part 28b is made of resinous material.

The ignitor 29 is accommodated in the outer casing 15 and positioned beneath the thermit casing 25. Including ignition agents, the ignitor 29 is constructed so as to ignite the ignition agents and allow the heating agents 27 to generate the thermit reaction heat. Note, the ignition agents can be ignited by heat generated by currents flowing through the leads 30a, 30b when the vehicle has an abnormality, such as collision.

The ignitor 29 is provided with a recess 29a. A compression spring 34 is arranged between the recess 29a and the bottom of the outer casing 15. In the condition of FIG. 3, the spring 34 is compressed.

When the heat of thermit reaction of the hearing agents 27 causes the metals 23 and the screw part 28 to be heated for melting, the compression spring 34 is expanded so that the thermit casing 25 jumps up against the cap 14, as shown in FIG. 6.

The so-constructed breaker unit 10 operates as follows.

In the normal condition, the first bus bar 11 and the second bus bar 19 are electrically connected with each other through the low-melting point metals 23 and the thermit casing 25, allowing the current to be supplied from the battery VB to the load 17 of FIG. 2.

When the vehicle collides with an obstacle etc. or the vehicle falls from over precipice etc., then this abnormality about the vehicle can be detected by a collision sensor (not shown) etc., generating a collision signal to the circuit breaker of the embodiment. Consequently, the current flows into the ignitor 29 through the leads 30a, 30b connected to the lead wires 31, which will be described in detail, later.

Then, owing to the ignition of the ignitor 29 caused by the generation of heat due to the above flow of current, the heating agents 27 produces a thermit reaction fever in accordance with a reaction formula as follows:

Fe₂O₃+2AL→AL₂O₃+2Fe+386.2 Kcal

This thermit reaction fever allows the thermit casing 25 to be heated. Thus, owing to the heat-generation from the heating agents 27 and also the fever from the thermit casing 25, the metal 23 welding between the leading end 13 of the bus bar 11 and the left sidewall 25a of the thermit casing 25 and the other metal 23 welding between the leading end 21 of the bus bar 19 and the right sidewall 25b of the thermit casing 25, are together heated to fusion. Simultaneously, the resinous screw part 28 for fastening the thermit casing 25 to the outer casing 15 is also heated to fusion.

Consequently, with the reduction of a fastening force of the thermit casing 25 to the outer casing 15, the compressed spring 34 is expanded and the thermit casing 25 and the ignitor 29 leap up, so that the casing 25 is accommodated in the cavity 22 in the cap 14, as shown in FIG. 6.

In this state, the electrical connection between the thermit casing 25 and the first and second bus bars 11, 19 is cut off. That is, the first bus bar 11 is electrically insulated from the second bus bar 19, causing the electrical circuit of the vehicle to be broken electrically.

According to the breaker unit 10 mentioned above, the input of the abnormality signal (collision signal) of the vehicle allows the ignitor 29 to be ignited to cause the thermit reaction in the hearing agents 27. As a result, the so-generated “thermit reaction” heat causes the low-melting point metals 23 and the screw part 28 to be molten, so that the compression spring 34 leaps up instantly.

In this way, it is possible to surely break off the electric circuit of the a vehicle in a short time, whereby the electrical components can be protected. In addition, owing to the use of thermit reaction heat of the heating agents 27, the breaker unit 10 can be simplified in structure.

Furthermore, since the arrangement of the screw part 28 resists an upward expansion of the compression spring 34, no spring force is applied to the low-melting point metals 23 between the thermit casing 23 and the bus bars 11 and 19, improving the reliability of these welding parts. Moreover, owing to the use of the compression spring 347 the breaker unit 10 can be produced at a low price and further facilitated in its design and assembling.

The electrical circuit of the circuit breaker of the embodiment of the invention will be described with reference to FIG. 2. The shown circuit breaker has a self-diagnostic function and includes the above breaker unit 10, a line switching relay 41, a switching element 42, OR gates 43 and 44, a judging unit 45, a current sensor 46, the electric load 17, the battery VB, a light-emitting diode LED, a resistance R and a transistor Tr.

The battery VB supplies an electric power to the load 17, for example, elements of a lamp system, those of a motor system and those of an ignition system, etc. The negative terminal of the battery VB is connected to the vehicle body for ground. The positive terminal of the battery VB is connected with the first bus bar 11 of the breaker unit 10, a cathode of the light-emitting diode LED and a normally-closed contact A of the line switching relay 41, supplying these elements with an electric power respectively.

The second bus bar 19 of the breaker unit 10 is connected with one end of the load 17, while the other end is connected to the vehicle body for ground. The ignitor 29 of the breaker unit 10 has one end connected to the switching element 42 through the lead 30a and the lead wire 31 (see FIG. 3) and the other end connected to the vehicle body through the lead 30b and the lead wire 31. The ignitor 10 is designed so as not to operate unless flowing of a current more than 1A, thereby preventing an erroneous operation of the ignitor 10 derived from noise in the normal condition.

The light-emitting diode LED corresponds to the display unit of the invention. An anode of the diode LED is connected to a normally-opened contact B of the line switching relay 41 through the resistance R. Emitting light when the current flows through the light-emitting diode LED, it is provided to inform an user that an obstacle is detected. Note, the light-emitting diode LED may be replaced with an incandescent lamp, a liquid-crystal display unit (LCD) or the other display unit.

The resistance R corresponds to the current limiting unit of the invention. Although the details will be described later, the resistance R is provided to restrict the current flowing through the ignitor 29 of the breaker unit 10 to the order of 0.4A. In the modification, the resistance R may be replaced with a variety of circuit elements for limiting the flow of current, for example, a transistor.

The line switching relay 41 corresponds to the line switching circuit of the present invention. The line switching relay 41 is provided to switch the current line between the first current line serving as an ordinary current line and the second current line serving as a current line at the diagnosis. A common terminal C in the relay 41 is connected to one end of the switching element 42. Further, the line switching relay 41 contains a relay coil having an end connected to the normally-closed contact A, that is, the positive terminal of the battery VB and the other end connected to a collector of the transistor Tr.

As the common terminal C of the relay 41 is normally connected to the normally-closed contact A, there is defined the first current line that passes the battery VB, the line switching relay 41 and the switching element 42 in order, so that the current of the battery VB is supplied to the switching element 42. While, if the relay coil in the relay 41 is excited, then the common terminal C is connected with the normally-opened contact B. Consequently, there is established the second current line where the current passes the battery VB, the light-emitting diode LED, the resistance R, the line switching relay 41 and the switching element 42 in order, so that the current from the positive terminal of the battery VB is supplied to the switching element 42 via the light-emitting diode LED and the resistance R.

The transistor Tr has an emitter connected to the vehicle body for ground and a base connected to an output of the OR gate 43. When the signal from the OR gate 43 is changed to “1”, then the transistor Tr is turned ON to excite the relay coil. Note, the transistor Tr may be replaced with another switching element capable of turning ON or OFF in response to the signal from the OR gate 43.

Against the input terminal of the OR gate 43, there are inputted a start signal that represents “1” for a fixed period when the ignition switch is turned on; a diagnostic signal that represents “1” on condition that a switch for self-diagnosis is turned on 1; and an error signal that represents “1” when the abnormality is detected by the judging unit 45. The output of the OR gate 43 is supplied to only the base of the transistor Tr but also an input terminal of the OR gate 44.

The switching element 42 is identical to a switch that is turned ON or OFF in response to the signal from the OR gate 44. For example, one transistor may form the switching element 42. The switching element 42 has an end connected to the common terminal C of the line switching relay 41 and the other end connected to the lead 30a and the judging unit 45.

Against the input terminal of the OR gate 44, there are inputted a signal from the OR gate 43, a breaking signal for driving the breaker unit 10 forcibly, a collision signal from a not-shown collision sensor and a signal from the judging unit 45. The breaking signal represents “1” when an emergency switch for stopping the vehicle urgently is manipulated or when a significant signal is outputted from an anti-theft sensor.

The current sensor 46 is interposed in the current line connecting the second bus bar 19 of the breaker unit 10 with the load 17 to monitor the current flowing through the load 27. The current value detected by the current sensor 46 is fed to the judging unit 45.

Corresponding to the first judging unit and the second judging unit of the invention, the judging unit 45 monitors the current flowing the ignitor 29 of the breaker unit 10 and further judges whether or not the circuit breaker has an obstacle. Based on this judgement, the judging unit 45 produces an error signal and outputs it to the OR gate 43. Additionally, the judging unit 45 judges whether the current detected by the current sensor 46 gets more than the predetermined threshold value. If the so-detected current is more than the above threshold value, then the unit 45 produces an emergency stop signal and supplied it to the OR gate 44. The breaking signal, the collision signal and the emergency stop signal mentioned above correspond to the abnormality signal of the invention, respectively.

The so-constructed circuit breaker operates as follows.

Firstly, we now describe the operation in case of detecting the existence of obstacle by the self-diagnosis. The self-diagnosis is carried out when the diagnostic signal from the outside has represented “1”. The diagnostic signal exhibits the value of “1” when the switch for self-diagnosis is manipulated.

When the diagnostic signal represents “1”, the output signal from the OR gate 43 gets the value of “1”. Then, the transistor Tr is turned on, so that the relay coil in the line switching relay 41 is excited. Consequently, the common terminal C of the relay 41 is connected to the normally-opened contact B. At the same time, since the signal from the OR gate 44 represents the value of “1”, the switching element 42 is turned on, so that the common terminal C in the relay 41 is electrically connected to the lead 30a of the breaker unit 10. As a result, there is established a current line containing the second current line when the current flows in the order as follows: the battery VB→the light-emitting diode LED→the resistance R→the line switching relay 41→the switching element 42→the ignitor 29 of the breaker unit 10→the vehicle body for ground.

In this state, if there is no fault in respective elements forming the above current line or these elements have no breaking-down or short-circuit therebetween, the current flows in the current line to light the light-emitting diode LED. In this way, the user can be informed that neither the breaker unit 10 nor the peripheral circuit has any obstacle in operation. Noted that the ignitor 10 is not ignited since the current is limited to the order of 0.4A by the provision of the resistance R. This means that the breaker unit 10 does not exhibit its inherent function so far as the self-diagnostic signal represents the value of “1”. Therefore, in case of the self-diagnosis during the vehicle's traveling, it is preferable to limit a time for keeping the diagnostic signal of “1” to the order of several seconds.

While, if the respective elements forming the above current line have any “open-mode” trouble or when there exists a breaking down among the respective elements (for example, at a point F in FIG. 2), the light-emitting diode LED does not light in spite of the diagnostic signal of “1”. In this way, the used can be informed that either the breaker unit 10 or the peripheral circuit has the “open-mode” trouble. Alternatively, if the current line shorts to the vehicle body for ground, for example, at the point F in FIG. 2, the light-emitting diode LED lights up however the value of “1” the diagnostic signal Ad may be. Thus, the user can be informed that either the breaker unit 10 or the peripheral circuit has the “short-circuit” trouble.

Note, by the provision of a not-shown control circuit, the diagnostic signal may be controlled so as to represent the value of “1” for only several seconds, for example, every dozens of seconds or several minutes, intermittently. In such a case, the used could be informed that neither the breaker unit 10 nor the peripheral circuit has any obstacle with the light-emitting diode LED lighting on and off: alternatively, either the breaker unit 10 or the peripheral circuit has any obstacle with the light-emitting diode LED keeping light-off or light-on.

Also in case of the value “1” of the start signal, which will represent the value “1” for a constant period since the ignition switch is turned on, the circuit breaker operates as similar to the operation of the above-mentioned case of the diagnostic signal representing the value of “1”. Accordingly, when starting the vehicle, the user's glancing at the light-emitting diode LED allows the circuit breaker to be checked as one item of the starting inspection.

Next, we describe the operation of the circuit breaker in case of detecting an obstacle in the normal condition after the vehicle's starting. Then, both of the start signal and the diagnostic signal are set to the values of “0”, respectively. Accordingly, the signal outputted from the OR gate 43 represents the value of “0”. Thus, the transistor Tr is turned off, so that the relay coil of the line switching relay 41 is not excited. Consequently, the common terminal C is connected to the normally-closed contact A.

Further, when the breaking signal, the collision signal and the emergency stop signal all represent the values of “0”, then the output signal of the OR gate 44 exhibits the value of “0”. In this case, the switching element 42 is turned off, so that there is established an open state between the common terminal C and the lead 30a of the breaker unit 10.

Under this situation, if any one of the breaking signal, the collision signal and the emergency stop signal is changed to “1”, then the switching element 42 is turned on thereby to supply the current into the ignitor 29 of the breaker unit 10. In this way, the breaker unit 10 is activated to cut off the current line from the battery VB to the electric load 17. While, if all of the breaking signal, the collision signal and the emergency stop signal are not the values of “1”, the judging unit 45 monitors a signal (current) in the line from the switching element 42 to the lead 30a of the breaker unit 10. If there is no obstacle in the line from the switching element 42 to the lead 30a of the breaker unit 10, the signal of low level is inputted to the judging unit 45. Then, the judging unit 45 judges that the above line has no obstacle in flowing the current, providing the user with no information.

To the contrary, if the above line is subjected to an electrical insulation at e.g. a point G in FIG. 2, a floating-level of signal is inputted to the judging unit 45. Then, the judging unit 45 judges that the above current line has an obstacle and further sets the error signal of “1”. Consequently, the circuit breaker operates as similar to the above-mentioned operation in case of the diagnostic signal of “1”, so that the light-emitting diode LED is lighted up. Further, as the diagnosis result that the obstacle has occurred in the above line, the judging unit 45 outputs a signal to drive a not-shown display unit embedded in a console panel (also not shown) of the vehicle. In this way, the user can be informed that the “open mode” obstacle is caused in the breaker unit 10 and the peripheral circuit.

The judging unit 45 makes the emergency stop signal of “1” when the detected current value from the current sensor 46 exceeds the threshold value. Then, the output signal from the OR gate 44 is changed to “1” thereby to turn the switching element 42 on. As a result, the flowing of current into the ignitor 29 causes the breaker unit 10 to be activated. Thus, the current line from the battery VB to the electric load 17 is blocked to prevent the load 17 from thermal influence.

In accordance with the above-mentioned embodiment, since the user's establishment of the diagnostic signal of “1” allows the obstacle in the peripheral circuit of the breaker unit 10 to be detected into information for the user, it is possible to operate the circuit breaker in the normal condition. Further, even when the user does not instruct the establishment of the diagnostic signal of “1”, the obstacle in the peripheral circuit of the breaker unit 10 is detected to inform the user of the presence of obstacle. Thus, it is possible to remove such an obstacle about the circuit breaker promptly, improving the safety, in an automobile or the like.

In the above-mentioned embodiment, the line switching relay 41 is employed as the line switching circuit for switching the current line between the first current line and the second current line. In the modification, as shown in FIG. 7, it may be replace with a circuit equipped with a NPN-type transistor Tr1 and a PNP-type transistor Tr2 for power units. In the shown modification, the NPN-type transistor Tr1 has a collector connected to the terminal A, an emitter connected to the terminal C and a base connected to the collector of the transistor Tr, respectively. While, the PNP-type transistor Tr2 has a collector connected to the terminal B, an emitter connected to the terminal C and a base connected to the collector of the transistor Tr, similarly.

The above-mentioned circuit operates as follows. In the normal condition where the transistor Tr is turned off, the transistor Tr1 is turned on and the transistor Tr2 is turned off, so that the current flows in the above-mentioned first current line. While, when the input of diagnostic signal causes the transistor Tr to be turned on, then the transistor Tr1 is turned off and the transistor Tr2 is turned on, so that the current flows in the second current line. In this way, since the illustrated circuit is similar to the line switching relay 41 in operation, it is possible to replace the relay 41 with the circuit of FIG. 7.

In addition, although the shown embodiment employs the breaker unit 10 of FIG. 3, it may be replaced with another breaker unit. For example, in connection with breaking means after ignition, it may be constructed such that the heat generation of heating agents causes gun-powder (not shown) to be To exploded to destroy a conductive member (e.g. the thermit casing 25 of FIG. 3) as a constituent of the circuit.

Again, it will be understood by those skilled in the art that the foregoing descriptions are nothing but one embodiment of the disclosed circuit breaker and the modifications. In addition to the above modifications, various changes and modifications may be made to the present invention without departing from the spirit and scope of the invention.

What is claimed is:

1. A circuit breaker for a vehicle, comprising:
a power source;
an electric load connected to the power source and also driven by the power sources;
a breaker unit disposed between the power source and the electric load, for breaking a current flowing from the power source to the electric load;
a driving unit disposed between the breaker unit and the power source to drive the breaker unit in response to an abnormality signal inputted from an outside of the breaker unit when the vehicle has an abnormality; and
a self-diagnostic unit connected to the driving unit to diagnose a normality of a current line from the power source to the breaker unit via the driving unit in response to a diagnostic signal inputted from an outside of the self-diagnostic unit.

2. A circuit breaker as claimed in claim 1, further comprising:
a display unit connected to the power source to display the current's flowing to an outside of the display unit; and
a current limiting unit connected to the display unit to restrict a current for driving the driving unit; wherein
the self-diagnostic unit has a line switching circuit for switching the current line between a first current line extending from the power source to the driving unit directly and a second current line from the power source to the driving unit via the display unit and the current limiting unit; and
the self-diagnostic unit diagnoses the normality upon switching the current line to the second current line in response to the diagnostic signal.

3. A current breaker as claimed in claim 2, further comprising a first judging unit connected to the first current line to judge whether the first current line has an obstacle in flowing the current; wherein
when the obstacle of the first current line is judged by the first judging unit,
the self-diagnostic unit allows the line switching circuit to switch the current line to the second current line thereby to diagnose the normality of the current line.

4. A current breaker as claimed in claim 1, wherein
the driving unit is adapted so as to receive a breaking signal to instruct the breaker unit to break the current flowing from the power source to the electric load, as the abnormality signal and also adapted so as to drive the breaker unit in response to the breaking signal.

5. A current breaker as claimed in claim 1, wherein
the driving unit receives is adapted so as to receive a collision signal representing the occurrence of an impact on the vehicle, as the abnormality signal, and also adapted so as to drive the breaker unit in response to the collision signal.

6. A current breaker as claimed in claim 1, further comprising:
a current detecting unit interposed in the current line to detect the current flowing from the power source to the electric load; and
a second judging unit connected to the current detecting unit to judge whether a value of the current detected by the current detecting unit is more than a predetermined threshold value, the second judging unit further outputting the abnormality signal to the driving unit when the value of the current is more than the predetermined threshold value; wherein
the driving unit drives the breaker unit in response to the abnormality signal from the second judging unit.

7. A current breaker as claimed in claim 1, wherein
the self-diagnostic unit is adapted so as to receive a start signal instructing the vehicle to start, as the diagnostic signal and also adapted so as to diagnose the normality of the current line from the power source to the breaker unit via the driving unit in response to the start signal.

8. A current breaker as claimed in claim 2, wherein the display unit is formed by a light-emitting diode.

9. A current breaker as claimed in claim 2, wherein the current limiting unit is formed by a resistance.
